(19) United States
(12) Patent Application Publication
(10) Pub. No.: US 2010/0051604 A1
(43) Pub. Date: Mar. 4, 2010

(54) SAFE PLANAR ELECTRICAL HEATER

(76) Inventors: Vladimir Nikolayevich Davidov, Dalkeith (GB); Alexander Roger Deas, Dalkeith (GB)

Correspondence Address: DARBY & DARBY P.C., P.O. BOX 770, Church Street Station, New York, NY, 10008-0770, US

(21) Appl. No.: 12/473,496

(22) Filed: May 28, 2009

Related U.S. Application Data
(60) Provisional application No. 61/056,647, filed on May 28, 2008.

(51) Int. Cl. H05B 3/02

(52) U.S. Cl. 219/488; 219/489

(57) ABSTRACT

An electrical heater element containing one or more sense wires located at a point or points between the power terminals that provides a voltage signal that is compared with a predefined level or ratio, to trigger a power supply trip should the sense voltage fall outside those limits.

This application claims priority under 35 U.S.C. §119 (e) to U.S. Provisional Patent Application Ser. No. 61/056,647, entitled “SAFE PLANAR ELECTRICAL HEATER,” and filed May 28, 2008, the contents of which are hereby incorporated by reference as though set forth in its entirety.

### BACKGROUND

There are two main types of direct electrical heater, as compared to indirect heaters using, for example, infra-red. The first type is a linear heater where a resistance wire is laid in a meander pattern over an insulating carrier. The second type of electrical heater is a planar heater, where the element is essentially two dimensional. Applications of linear heaters are widespread, such as in electric fires or electric bed warmers. Applications of planar heaters include electric surgical blankets, heated garments, visor heaters, glove heaters, equipment heaters, engine heaters, rebreather counterlung heaters, heated rebreather hoses, heated rebreather flapper valve structures, heated diving suits, heated motorcycle garments and ski boot heaters. This patent is concerned primarily with planar heaters, but the invention also has some application to linear heaters having sufficient parallel conductors to form a plane, such as a device using a woven polymer or woven mesh as a heating element.

Planar heaters have been available for decades, first using wire mesh woven from high resistance metal compounds such as nichrome and stainless steel, then more recently, conductive polymers in sheet, woven or moulded form. In some cases the planar heating element can take three dimensions, if a sheet or fabric is sewn into a garment form or if the conductive polymer resin is moulded directly into a three dimensional form. In these three dimensional structures, the flow of electrical current is still from one linear bus bar or contact area region to another, so the material heating element itself remains essentially planar, or multi-planar when multiple electrical terminals are used.

Planar heating elements can be fabricated out of any of many different materials, including but not limited to fine stainless steel wire mesh, nichrome wire mesh, conductive polymer films or sheet, injection moulded conductive forms, conductive polymer textiles, mats or felts of chopped conductive fibre, conductive organic molecular pastes, carbonised organic woven textiles, and using almost any of the other techniques known for creating synthetic yarns, textiles and garments. For simplicity, the word ‘fabric’ will be used to describe all such planar conductive heating elements and references to conductive fabric are references to the conductive heating element, regardless of whether the heating element is strongly conductive or weakly conductive, or semi-conductive, and regardless in which form the element takes.

The resistance of conductive polymers tends to be much higher than that of wire meshes: typically 14 Ohms per square for the polymer compared to 3 Ohms per square for an ultra fine stainless steel mesh. The conductivity of the polymer can be controlled easily at the time it is fabricated by adjusting the amount of carbon or conductive material that is added to the polymer, or by cutting slots into the fabric to reduce the cross section of the heater, improve flexibility and reduce current sharing between power rails.

Power is normally supplied to the heater using a highly conductive bus bar, such as a plated copper braid, that is moulded into the element, or attached to the element by stitching, crimping or clamping. To apply power to the conductive fabric, electrodes such as tin or gold plated copper braid are usually stitched or clamped to the edges of the conductive fabric, though it is generally more desirable to embed the conductor into the polymer at the time the polymer is fabricated into the desired form. Metal threads or highly conductive polymers can be included in a weave with fewer conductive polymers, so that electrical power is distributed within the garment by a widely distributed bus bar.

Heating elements fabricated by loading a polymer with carbon seem to have first appeared as products that were produced and sold in Russia around 1980. These were fabricated by adding a dentritic form of carbon black to a chemically-setting (vulcanizing) polymer, such as two-pack silicone, or to a low-temperature thermoplastic, such as polyurethane or polyethylene, when the plastic is in a molten state. Up to 18% carbon can usually be added to a plastic before it becomes too friable, but if the carbon is highly dentritic, just a few percent is generally sufficient to achieve the desired bulk conductivity. A dentritic shape is a tree-like shape. When the dentritic carbon is added to polymers, the polymer becomes conductive or semi-conductive, and offers a degree of thermal self-stabilisation when a current is applied, because as the temperature increases the “branches” of these “trees” move apart due to thermal expansion, and as their “branches” become less interwined the electrical resistance increases. The self-stabilisation effect is sufficiently pronounced for a fixed voltage to be applied, and in a dry environment the material will reach a self limiting temperature that can be independent of the thermal load placed on the pad, that is, how much it is cooled.

The production of an item from conductive polymers and fibres can be very simple. For example, to make a conductive boot liner, a dentritic carbon black such as Cabot Vulcan XC72, can be added to two-pack chemically-setting silicone, mixing well, until the desired conductance is achieved. The mixture can then be poured to form a film that is later glued into the desired shape, or injection moulded under either pressure or vacuum, or pushed through a nozzle to form a fibre which is later woven, or chopped and pressed to form a mat that is stitched together. Often the conductive polymer is cast or woven or moulded around a nylon or other polymer mesh to impart mechanical strength to what can otherwise be a weak material, such as silicone. Conductors can be stitched to the resulting form, current applied, and the form will then heat up.

In Europe, companies such as EXO2 Ltd in Scotland have produced heated panels and garments since the late 1990s, using conductive polymers produced by these methods of adding carbon to a polymer resin. Interest in conductive polymers and conductive molecules has accelerated, and now is the basis of many types of heated garments and 3D forms available commercially in Asia, the USA and Europe, as well as in Russia where they started.

Many different production processes to produce planar conductive sheets, fabrics or forms have been developed, from those described above, where carbon or metals are added to a polymer, to those that carbonize or reduce the outer layer of an organic, or that treat a fabric to deposit a carbon-loaded film onto an insulating fibre. A good summary of the state of the art in conductive polymers is provided by the four-volume “Handbook of Organic Conductive Molecules and Polymers”, edited by H. S. Nalwa and published by J. Wiley & Sons, ISBN 0-471-96595-2.

The garments normally operate with very low voltages (almost always under 24V, and usually 3V to 6V), to avoid the wearer receiving an electrical shock. In some environments, such as marine use, there are requirements to screen the heating element, such as in IMCA AODC guidelines.

There are several fault modes where the electrically heated fabrics can present a safety hazard. The inclusion of carbon means the user is wearing a fuel, and use of silicones and other plastics often means there is a large amount of free oxygen available to cause a runaway exothermic reaction once one part of the fabric overheats. Temperatures of 1000° C. or more can be generated in these reactions, and they have been reported even in atmospheres where very little oxygen is available, such as in helium.

It is known that a safety hazard exists, even when a one dimensional heater is incorporated into a garment. A good example is nichrome wire heaters for diver thermal balance. When these were tested in the North Sea in the 1970s and early 1980s, some divers suffered burns down to the bone, and there are reports of a fatal accident from these heaters. Thermal runaway of a heater destroys the nerve endings that stimulate pain, and heat underwater is difficult to distinguish from acute cold. The nichrome heater does not contain the fuel and excess oxygen that are a feature of the more modern materials. The more modern conductive polymers can therefore be considered to represent an even greater hazard than the earlier nichrome heaters.

Overheating of the fabric heater can be initiated through any of several mechanisms:

1. Reduction in conductor contact. Over time the conductive braid that is generally used to make contact with the conductive fabric, suffers wear and corrosion. This can reduce the contact area. As the contact area reduces, the temperature around the remaining contact points can increase substantially. The reduction in conductor cross section may occur in the cable to the heater pad, as well as on the pad itself.

2. Electrolytic action occurs in environments were there is a conducting liquid, usually salts dissolved in water. Most liquid environments are very mildly electrolytic, but when the liquid penetrates into the heater element, the liquid tends to evaporate due to the heat, leaving behind salts, which with subsequent liquid ingress results in a more conductive solution around the heater. These cycles can repeat until the electrolyte has a sufficiently high conductivity to cause local overheating of the heater element.

3. The presence of gases or liquids that conduct heat well can form local hot spots. The most acute case seems to be the presence of helium under pressure. In one incident, where a fabric heater was used as the heating element in the inhale counterlung of a rebreather, to heat the recirculated gas, the heater caught fire after 16 minutes, even though the partial pressure of oxygen was very low. These results were published on www.rebreatherrworld.com. The fire required temperatures of over 400° C. to initiate, but the self stabilizing temperature of the fabric heater in air was just 70° C.

In many environments where heated fabrics are used, such as a heater for a diver, or a heater for surgical use on an anesthetized patient, the local overheating can result in severe burns or death.

Attempts have been made to mitigate these risks by sealing the heater from the liquid, but sooner or later the seal breaks and a hazardous situation is created.

An attempt was made to embed distributed heater monitoring into the conductive fabric, using a flexible polyimide circuit board with gold-coated copper conductors, part of which was covered with an insulating solder screen, as shown in FIG. 1. The device in FIG. 1 was presented publically by Sjur Lothe to an IMCA meeting in August 2007 and by John Nortcliffe to the Scientific Dive Seminar in Bergen held in November 2007. The design in FIG. 1 features both a monitor to detect an excessive voltage drop in the supply conductors and a meandering trace to detect local overheating. Unfortunately the large area of the circuit meant that it delaminated easily from the silicone film it was sandwiched in, so the approach did not work reliably as the fabric film was flexed. Another problem with this prior art, is that is relies on very low level signals from the meander trace, which can be affected by electrical noise in many operating environments.

Another attempt was made to provide a degree of safety for a polymer-film type of planar heater by monitoring the voltage on a conductor or electrode placed on the polymer at the midway position between the two power electrodes. However, the inherent two-dimensional aspect of the fabric heater resulted in the central conductor failing to detect failure of the supply conductor or of some electrolytic conditions, while at the same time being prone to false alarms, triggering a power trip when no hazard existed because of uneven cooling loading on the heater pad. This attempt has not been disclosed publicly but is presented here by the present inventor as background to the understanding of this invention.

### OBJECT OF THE PRESENT INVENTION

It is an object of the present invention to enable a heater to operate safely, including in environments where electrolytes may be present.

It is a further object of the present invention to improve the safety of heaters to enable them to be used in safety critical environments.

It is a further object of the present invention to monitor the safety integrity of the cables carrying current to the heater element, to ensure that a reduction in cable cross section does not cause a local hot spot in the cable.

It is a further object of the present invention to enable the heater to be applied as an intrinsically safe heater for those environments where an explosive or reactive gas may be present.

### SUMMARY OF THE PRESENT INVENTION

The present invention relates to an electrical heater comprising a heating element and one or more conductive sense wires connected to the said heating element in a predetermined position between the points at which power is applied to the element, wherein the said one or more sense wires is further connected to a voltage detector for comparing that voltage with a predetermined value or fraction and triggering a safety indicator or safety trip if the voltage is outside the predetermined range or tolerance.

In an embodiment of the invention, an electrical heating element comprises a plurality of said sense wires to provide a plurality of sense signals.

In an embodiment of the invention, the said heating element is a planar heating element.

In an embodiment of the invention, the heating element is a conductive or semi-conductive sheet, mesh or fabric. In another embodiment, the said heating element is a three dimensional moulded form.

In still another embodiment of the invention, one or more conductive sense wires is placed in a predetermined position on a conductive fabric, preferably close to the power or ground supply conductors, to detect the change in voltage of that sense wire to trigger a trip or cut-out of the power supply to the heater.

In another aspect of the invention, an electrical heating system is provided comprising an electrical heater having a heating element and one or more conductive sense wires connected to the said heating element in a predetermined position between the points at which power is applied to the element, wherein the said one or more sense wires is connected to a voltage detector for comparing that voltage with a predetermined value or fraction and activating a power regulator that reduces or cuts off the power to the heating element if the voltage is outside the predetermined range or tolerance.

In an embodiment of an electrical heating system according to the present invention, the sense signal or trip signal is masked periodically, allowing the signal to settle, before it is enabled for use as a safety trip.

In an embodiment, an electrical heating system further incorporates a second trip circuit for over-current protection. In a further embodiment, an electrical heating system further incorporates a third trip circuit that triggers when the screen voltage is non-zero.

In an embodiment of the invention, an electrical heating system further incorporates a temperature sensor indicating the temperature of the heating pad, using a voltage across the resistance of the pad.

In an embodiment of the invention, an electrical heating system is provided, where the safety function driven by the voltage sensed on the heating element is combined with a heater power controller to regulate the heat output of a heater.

In an embodiment of the heating system according to the invention, the power regulator combines a power switch used for trip purposes with a variable pulse width signal or variable amplitude signal pulse width modulation.

### BRIEF DESCRIPTION OF THE INVENTION AND FIGURES

The invention will now be described by way of example, without limitation to the generality of the invention, and with reference to the following figures:

FIG. 1 shows a prior art embodiment of an alternative method of monitoring a heating pad, referred to earlier, embodying a meander trace to detect overheating of the conductive polymer, along with other features common to heater safety circuits, including over-current protection and sense wires to detect an excessive voltage drop on the supply conductors. This panel was fabricated using a flexible circuit board with selective solder resist to prevent the meander track from shorting to the conductive polymer, onto which the flexible circuit board was bonded with the aid of rivet points through which the polymer flowed to fix the panel securely to the polymer heater panel.

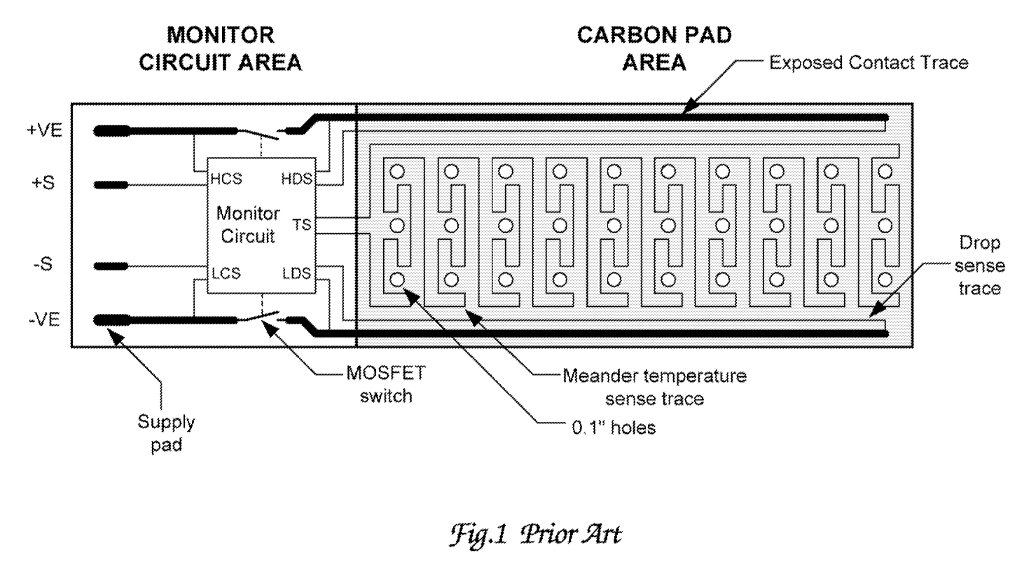

FIG. 2 shows an example of a heater panel fitted with power and sense conductors according to the present invention where the panel comprises a conductive fabric or conductive polymer film (3) onto which electrical current is supplied via a high-side conductor or bus bar (1) and a low-side conductor or bus bar (5). In this example the conductive fabric is fitted with two sense conductors or traces (2) and (4) to sense the voltage on the conductive fabric at a point between the high-side conductor or bus bar (1) and low-side conductor or bus bar (5), and in this case the sense conductors or traces (2) and (4) are positioned closer to the high- and low-side power conductors or bus bars (1),(5) respectively rather than in the centre of the pad. Suitable conductors for the power (1), ground (5), and sense conductors or traces (2), (4) include tin- or gold-plated copper braid that is stitched or crimped onto the conductive polymer, or preferably, embedded into the polymer with the braid being either loose or pulled apart at intervals to allow the polymer to flow through the braid to secure it in the polymer and reduce the risk of delamination between the polymer and the conductors. The whole heater panel or pad would normally be protected by enclosure in a waterproof or hydrophobic membrane, which may have an electrically conductive screen laminated to an outer surface or to a layer in a sandwich of protective membranes.

FIG. 3 shows a block diagram of an example embodiment of an electronic circuit driving and monitoring the heated panel shown in FIG. 2, comprising a first power terminal (10) and second power terminal (14) across which a power voltage is supplied such as 12VDC: an AC supply can be used in some embodiments but the circuitry tends to be more complex than for a DC supply. The example embodiment shown in FIG. 3 also contains current sense circuits (16), (20) on the positive and negative rails respectively, a means to isolate the heater pad from the power supply using switches (22),(28), to which are connected the high- and low-side supply conductor or bus bars (1),(5) respectively. The sense conductors or traces (2),(4) are each connected to a voltage comparator (24),(26) that provides either a full window comparison or a comparison with a predefined voltage or fraction of the power voltage, to drive the control logic (18) so that when either the voltage comparator is tripped or the power current sense circuits show an over-current or current imbalance, the heater pad supply rails (1),(5) can be isolated by switching the high- and low-side switches to open circuit. The control circuit includes a means of reset so that on power-up the high-side switch is connected for long enough to allow current to travel through the pad to obtain a useful voltage reading from the high-side voltage comparator and determine whether current should continue to flow, i.e. the trip is masked briefly on power being applied.

FIG. 4 shows a circuit implementing a variant of FIG. 3, comprising Resistors R1 (30) to R7 (44) where R1 (30) to R6 (40) are a ladder chain providing reference voltages to voltage comparators U2 (46). U3 (48), U4 (50), U5 (52), U7 (56) and are connected with U1 (42) as a wire OR using positive logic (so these comparators in this example embodiment circuit are open-emitter comparators), to an AND gate U8 (60) with integral pull down on its inputs, an inverter U9 (64), NOR gates U10 (72) and U11 (66), connecting to a single high-side switch comprising MOSFET M1 (74), diode D1 (70) and smoothing inductor L1 (68). The heater pad assembly has a screen (90) connected to voltage comparator U1 (42) and R7 (44) with a reference voltage V1 to provide a trip if there is a short between the heating pad element (3) and the screen (90) caused, for example, by electrolyte ingress (86). A low-side current sense trip is provided by voltage comparator U7 (56) and R6 (40), and a current sense output (84) is provided using an amplifier U6 (54). The circuit in FIG. 4 has a top-side switch (22) comprising a FET M1 (74), with inductor L1 (68) and a diode D1 (70), driven by a latch circuit comprising U8 (60), Delay DL1 (62), inverter U9 (64) and NOR logic gates U10 (72) and U11 (66), but has no low-side switch (28). The PWM pulse stream from circuit input node (82) drives the latch to switch on power, but if after a short delay, determined by DL1, the circuitry does not allow the comparators to reach the state where their outputs are all low, then the high-side switch (22) opens again. All output nodes are pulled down externally. The Power and Ground supplies are connected to terminals +VE (80) and 0V (88) respectively. Power and ground connections to the integrated circuits U1 to U11 are not shown for reasons of simplicity: they can be connected to +VE (80) or 0V (88), subject to their power supply range being suitable; alternatively they can be powered externally to this circuit using suitable voltage regulators. All devices shown may be integrated circuits or discrete components, or software functions using an ADC and firmware.

### OPERATION OF THE PRESENT INVENTION

The operation of the invention will be described, by reference to example embodiments without limit to the generality of the invention. For brevity, the examples will assume the user is a diver and the application is a heater for use inside a diver's dry suit while being worn underwater. Other environments that behave in a similar manner are patient heaters during surgery, where body wastes or blood plasma form the electrolyte, or in the counterlung of a rebreather where condensate contaminated with salts from the scrubber, cleaning solution or bacteria forms the electrolyte.

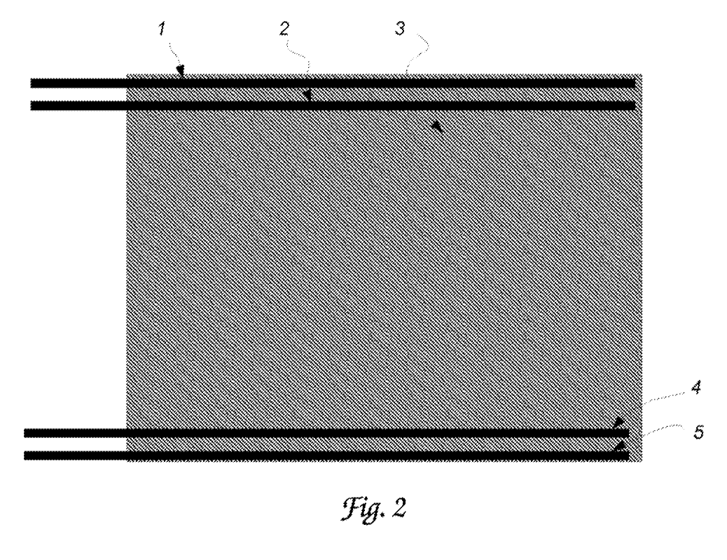

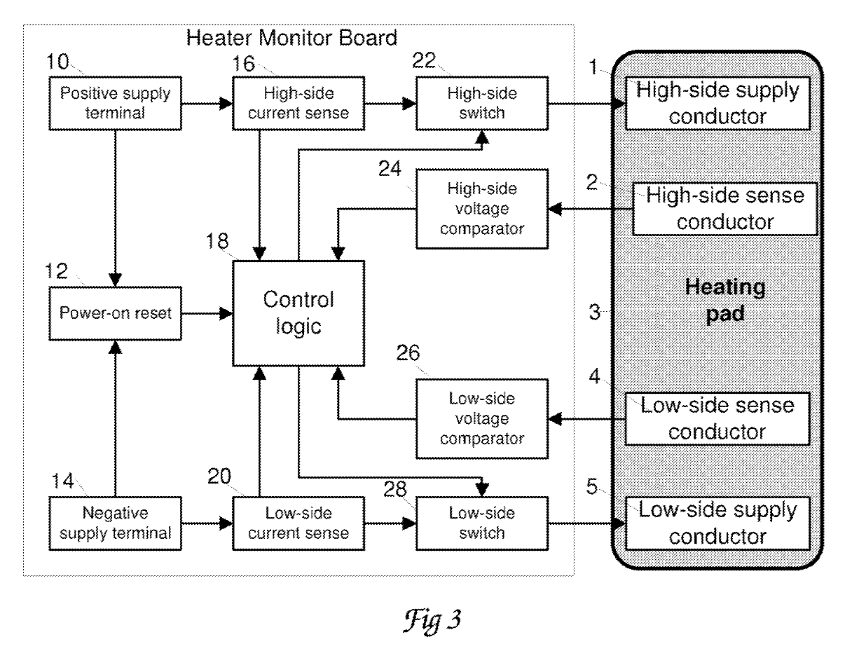

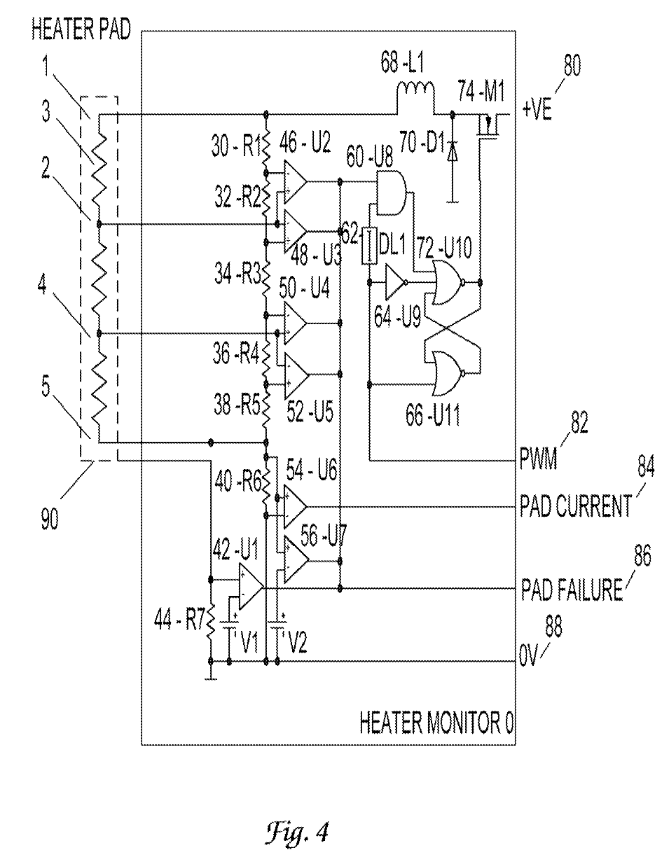

The functionality of the present invention should be apparent to a person skilled in electronics from FIGS. 2 and 3 in conjunction with the example embodiment circuit in FIG. 4.

To avoid ambiguity, the circuit in FIG. 4 will be described as a specific embodiment, without loss of generality, by relating the example implementation of circuit functions in FIG. 4 to the features in the diagrams forming FIGS. 2 and 3.

In FIG. 4, the heater pad structure shown in FIG. 2 is represented as three linear resistors, whereas in fact the resistors are a two or more dimensional structure formed by the regions of the conductive fabric between the bus bars and sense traces (1), (2), (4) and (5) in FIGS. 2, 3 and 4.

In FIG. 4, an N-type MOSFET M1 (74), diode D1 (70) and inductor (68) are used to implement the high-side switch function (22, in FIG. 3). The high-side switch function (22) is used to both isolate the heater pad and also to adjust the power level to the pad using a Pulse Width Modulation (PWM) scheme generated externally to FIG. 4, supplied to the circuit input node 82. The PWM pulse stream may be generated, for example, by a state machine, from an analogue circuit or even from a microcontroller that has switches connected to it to allow the user to request an increase or decrease in pad temperature, along with an OLED dot matrix display to see parameters of the heater that may include the heater power level, temperature and safety status. There is no low-side switch (28) in FIG. 4: the example embodiment in FIG. 4 uses just high-side heater pad isolation to reduce the losses in the power management circuitry.

When the PWM stream applies power via M1 (74), the outputs of the voltage comparators will be in a state that may indicate the sense voltages from the sense conductors or traces (2), (4) are outside the permitted range, due to the time delay or inertia in the circuit from capacitance and inductances. This would tend to switch off the high-side switch (22), so to prevent this undesirable action, a latch with a delay function DL1 (62) is used to interface the comparator wire OR'd outputs to the high-side switch MOSFET M1 (74). An example embodiment of the circuitry of this interface is shown in FIG. 4, comprising U8 (60), U10 (72), U11 (66), U9 (64) and DL1 (62). The value of DL1 (62) would normally be in the range of several milli-seconds, but may be longer or shorter depending on the application. The optimum value can be determined by building the circuit and measuring the time it takes for the voltage comparator outputs to settle after the high-side switch transistor M1 (74) is closed, then making the delay DL1 (62) longer than that settling time.

The example embodiment in FIG. 4 uses full window comparison to detect whether the voltages measured by the sense conductors or traces (2), (4), are within the desired tolerance. The voltage on the conductive fabric (3) will normally vary linearly from 0V to +VE minus the voltage drops across the high- and low-side switches (22), (28). Conductive polymers, particularly, will show a local variation in voltage depending on the temperature other parts of the fabric have reached. For example, if half of a carbon-loaded conductive polymer is placed in dry ice with the other half in hot air, then the part in dry ice will have a significantly lower resistance than the part which is in hot air. Assume the heater has the power (1) and ground (5) conductors 100 mm apart, with sense conductors (2), (4) 40 mm away from the centre line (i.e. the low side sense conductor (4) is attached to the conductive polymer heater (3) at a distance 10 mm away from the 0V conductor(5)), and the high side conductor (2) is 90 mm away from the 0V conductor (5). Assume also that the part of the heater that is in the dry ice is the half that includes the 0V power conductor (5). Under those conditions the voltage on the low side sense conductor (4) may be only 5% of +VE when M1 is on, and the voltage on the high side sense conductor (2) may be 80% of the voltage +VE, instead of their normal values of 10% and 90% of VE respectively. If the heater panel is designed to operate under such marked temperature gradients across the heater pad (3), then the low-side window comparator (26) may have to be set for a range of 4% of +VE to 25% of +VE to avoid false trips, and the high-side comparator (24) at 96% to 75% of +VE, but generally the smaller the range, the safer the product will be.

As both sense conductors in this example will generally show an abnormal reading under fault conditions, only one sense conductor need be used in some applications. In other applications multiple circuits may be required, supplied, for example, by connecting a plurality of the circuit shown in FIG. 4 in parallel. In general, when a failure occurs, it will tend to occur closer to either the positive or negative supply rail: which one depends on what the electrolyte is and the operating environment. In that case, it is preferable to include the sense conductor closest to that rail, while the other conductor then has a lower significance.

The sense conductor or trace should not normally be equidistant between the 0V and +VE power conductors or bus bars (1), (5) because when a failure occurs, the two dimensional nature of the heater element (3) causes power to be shared across the fabric, resulting in a local hot spot near power supply rails, causing the voltage in that area to change, while the voltage in the centre of the pad tends not to change significantly from its usual value under the same fault conditions. This can be demonstrated by connecting the power to the fabric via a small bolt: that is, replacing the long finger strips that would form the power conductors (1) and (5) with bolts. When power is applied, the area immediately around the bolt will heat up considerably more than the centre of the pad, because the current density is highest near the power terminal. The voltage across the fabric will change from that where the power and ground, or 0V, terminals (1) and (5) are long strips of braid, especially very close to the terminals, but the voltage in the centre of the fabric will be unchanged in several of the fault modes for these planar heaters. The temperature of the bolts will rise, and with sufficient power will reach very high temperatures that can trigger ignition of a carbon-loaded silicone. The total current consumed by the heating element (3) may be within a normal range, but the extreme distortion of the power distribution and concentration of the voltage differential around the area of the terminals will cause local overheating. Due to these effects, it is generally preferable for the sense conductors or traces (2), (4) to be close to the power conductors or bus bars (1), (5).

When the circuit in FIG. 4 is powered up, the PWM signal is low, so the input to the NOR gate U10 (72) via the inverter U9 (64) is high, hence the output of the NOR gate U1 (72) is low, and the high-side switch MOSFET M1 (74) is off. The next step in the operation is when there is a rising edge of the PWM signal. This causes the inverter U9 (64) output to go low, and as the delayed input to U8 (60) is low at that time, U1 (72) switches to high. The AND gate U8 (60) remains low for the length of delay in the delay element DL1 (62): the output of the comparators is initially unknown so the effect of DL1 (62) is to mask their output for the period of time it takes for the PWM high signal to propagate through the delay DL1 (62).

The outputs of U2 (46), U3 (48). U4 (50), U5 (52), U7 (56) and U1 (42) are wire OR'd together with positive logic. They can be implemented directly, or by application of De-Morgan's theorem, the following logic and inputs can be inverted to enable more common open-collector or open-drain-stage devices, such as LM339, to be used. In practice, the devices U8, U10, U11 may be implemented using discrete components, as integrated parts that can manage high voltages are not readily available. For example, the cross coupled flip-flop U10 (72) and U11 (66) can be implemented using two cross-coupled MOSFETs that tolerate higher voltages than common CMOS, such as EXM61NO3F devices.

The example circuitry forming the high side switch (22) in FIG. 4, is MOSFET M1 (74), diode D1 (70) and inductor L1 (68). The purpose of the MOSFET M1 (74) is to turn the power supply on and off, the purpose of the inductor L1 (68) is to limit the current to the pad on switch on to protect the MOSFET, and the purpose of the diode is to limit the flyback voltage when the MOSFET M1 (74) is switched off to prevent damage to the MOSFET.

The circuit in FIG. 4 shows how two other safety features can be integrated with the present invention, namely over-current monitoring and screen failure monitoring. The over-current sense circuitry (20) is on the low side only in FIG. 4, comprising a sense resistor R6 (40), voltage comparator U6 (54) and U7 (56), with voltage reference V2. When the voltage drop across R6 (40) exceeds voltage V2, then the output of U7 (56) switches high, forming a wire OR with the other comparator outputs and putting a high signal on the AND gate, so that when the PWM is applied to the circuit, apart from a short period for delay DL1 (62), the output of U8 is high and the output of U10 (72) is low, switching off the heating pad. The safety screen monitor works in a similar manner, detecting when there is a voltage other than 0V on the screen (90) around the heating pad, and switching off the pad under those conditions: for example, when an electrolyte has entered the waterproof sleeve that is normally around the heater.

A person skilled in the art will appreciate that some of these features can be omitted, within the present invention. For example, an embodiment has been described that uses only one high-side switch (22) and one low-side current sensor circuit (20): both these functions could be omitted completely within the present invention. The number of sense conductors or traces can be determined by the needs of the application: two is a preferred number, but any number of sense traces can be used, from one upwards, at the cost of additional circuitry.

Where there are large numbers of heating pads, the circuit shown in FIG. 4 can be used either as an instance per heating pad, or the power and sense wires of the heating pad itself can be connected in parallel.

In the circuit in FIG. 4, a Pad Failure output (86) is provided to a monitoring circuit to detect pad failure. It is possible to connect each comparator output to such a monitor, to provide more detailed diagnostics or alerts.

In the circuit in FIG. 4, a Pad Current output (84) is provided that can be used to determine the resistance of the pad, and hence the mean temperature of the heating pad, by comparing the measured voltage against a calibration table or table of predefined values. That measurement can be taken during the delay period DL1, to obtain information even under conditions where the trips on the circuit are preventing the circuit being powered normally, by masking the signal to the high-side switch MOSFET M1 (74). The example given in FIG. 4 allows the high side switch (22) to be used for both the purposes of a safety trip device and as a device that controls the power output of the heating pad by mixing the safety trip signal with a PWM or Pulse Code Modulated signal. The same technique can be applied, using suitable circuitry that will be apparent to a person skilled in the art, to adjust the voltage applied to the gate of the MOSFET or switch, to regulate the power to the pad by varying the power voltage to the pad. Another method of achieving the same result is to mix the safety trip signal with a variable very high frequency signal such that the combined effect of the inductor L1 (68) and the capacitance of the pad results in the inductor passing only a portion of the energy to the resistance formed by the pad.

Many different forms of conductor pattern are possible for the power conductors or bus bars (1), (5) and sense conductors or traces (2), (4). For example, a main bus bar can be stitched on one side of a sheet of conductive fabric, and interdigitating fingers can be stitched to the other side, with a wrap-around over the edge of the conductive fabric to provide a low resistance connection. Where the polymer has a very low conductivity, a conductive metal may be laminated to each side and the power applied to that. In this case the sense wires would be moulded or sandwiched into the body of the polymer. In another case, the power conductors can be crimped to the edge of the polymer, and folds made in the polymer sheet of fabric, onto which are crimped the sense conductors. In yet another embodiment, highly conductive fibres can be woven with less conductive fibres and connected to a highly conductive polymer bus bar using plastic welding methods.

Additional trips can be incorporated into circuits embodying the present invention, such as current imbalance trips, wet contacts and gas pressure trips, where the gas is the gas inside the water and gas tight sleeve containing the heater element.

The present invention can be applied to linear resistance heaters, but in general it is an inefficient safety solution for those heaters because simple monitoring of the current in the heater under known voltage supply conditions is enough to detail all main failure modes, unless there are many parallel conductors that form a plane, at which point it becomes a planar heater.

1. An electrical heater comprising
a heating element and
one or more conductive sense wires connected to the heating element in a predetermined position between points at which power is applied to the heating element, wherein the one or more sense wires is further connected to a voltage detector, to compare a voltage from the voltage detector with a predetermined range, and triggering a safety indicator or safety trip if the voltage is outside the predetermined range.

2. A device according to claim 1, wherein a plurality of such sense signals are obtained from the heating element.

3. A device according to claim 1 wherein the heating element comprises a planar heating element.

4. A device according to claim 1 wherein the heating element comprises a material selected from the group consisting of a conductive sheet, a semi-conductive sheet, a mesh, and a fabric.

5. A device according to claim 1 wherein the heating element comprises a three dimensional moulded form.

6. An electrical heating system comprising:
a heating element; and
one or more conductive sense wires connected to the heating element in a predetermined position between points at which power is applied to the heating element,
wherein the one or more conductive sense wires are connected to a voltage detector for comparing a voltage from the voltage detector with a predetermined value, and activating a power regulator that reduces the power to the heating element if the voltage is outside the predetermined range.

7. An electrical heating system according to claim 6 wherein a sense signal from the one or more conductive sense wires is masked periodically, to allow the signal to settle before the signal is enabled for use as a safety trip.

8. An electrical heating system according to claim 6 further incorporating a trip circuit for over-current protection.

9. An electrical heating system according to claim 6, further incorporating a trip circuit that triggers when the screen voltage is non-zero.

10. An electrical heating system according to claim 6, further comprising a temperature sensor indicating the temperature of the heating pad, using a voltage across the resistance of the pad.

11. An electrical heating system according to claim 6, where the voltage detector is combined with a heater power controller to regulate the heat output of a heater.

12. An electrical heating system according to claim 6, wherein the power regulator comprises a power switch used in a trip circuit with a variable pulse width signal.

13. An electrical heating system according to claim 6, wherein the power regulator comprises a power switch used in a trip circuit, to regulate power to the heating element by varying the power voltage to the heating element.

14. An electronic circuit to drive and monitor an electrical heater, the heater having a high-side electrical bus bar, a low-side electrical bus bar, a first heater sensor responsive to the high-side electrical bus bar, and a second heater sensor responsive to the low-side electrical bus bar, the electronic circuit comprising:
a first and a second power terminal, wherein a power voltage is supplied across the first and second power terminals;
a first rail to electrically connect the first power terminal to the high-side electrical bus bar, the first rail comprising:
a series connection of a first current sense circuit and a first switch;
a second rail to electrically connect the second power terminal to the low-side electrical bus bar, the second rail comprising:
a second current sense circuit;
a first voltage comparator to compare an output of the first heater sensor to a first predetermined threshold;
a second voltage comparator to compare an output of the second heater sensor to a second predetermined threshold;
a control logic to receive outputs from the first and second voltage comparators and from the first and second current sensors, wherein the control logic drives the first switch in response to the received outputs;

15. The electronic circuit of claim 14, wherein:
the second rail further comprises a second switch in series with the second current sense circuit; and
the control logic is further configured to drive the second switch in response to the received outputs.

16. The electronic circuit of claim 15, further comprising a circuit to mask the control logic driving at least one of the first and second switches upon power being applied.

17. The electronic circuit of claim 14, further comprising an output indicator from the control logic, to indicate a failure of the electrical heater.

18. The electronic circuit of claim 17, wherein the output indicator includes diagnostics.

19. The electronic circuit of claim 14, wherein the control logic drives the first switch for a purpose of both a safety trip device and a control of power delivered to the electrical heater.

20. The electrical heater of claim 4, further comprising a bus bar to deliver electric power to the heating element, wherein the connection of the bus bar to the heating element comprises:
a first stitching on one side of a sheeted heating element;
a second stitching of interdigitating fingers, the second stitching stitched to an opposite side the sheeted heating element; and
a wrap-around over the edge of the sheeted heating element to provide a low resistance connection between the first and second stitchings.
